(19) United States
(12) Patent Application Publication
(10) Pub. No.: US 2002/0195939 A1
(43) Pub. Date: Dec. 26, 2002

(54) Plasma display panel and method of manufacturing plasma display panel

(75) Inventors: Akifumi Okigawa, Tokyo (JP); Toshihiro Yoshioka, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, Tokyo (JP)

(21) Appl. No.: 10/178,248

(22) Filed: Jun. 25, 2002

(30) Foreign Application Priority Data
Jun. 25, 2001 (JP) 2001-191765

(51) Int. Cl. H01J 17/49

(52) U.S. Cl. 313/584

(57) ABSTRACT

A plasma display panel having a plurality of surface discharge electrode pairs formed in a column direction at predetermined intervals, each surface discharge electrode pair having a pair of sustaining electrodes extending in a row direction so that a discharge gap is put between the sustaining electrodes. Each sustaining electrode is made up of a transparent conductive thin film, is provided with a main electrode portion formed in stripe shapes so as to face the discharge gap and a metal film of which a width is narrower than a width of the main electrode portion, and a sub-electrode portion formed at a side opposite to the discharge gap side of the main electrode portion which corresponds. With this configuration, a high image quality and a low power consumption can be obtained.

### BACKGROUND OF THE INVENTION

1. Field of the Invention

The present invention relates to a plasma display panel used as a flat display for a television receiver, a computer, and a like, and a method of manufacturing the plasma display panel (PDP), and more particularly, relates to an AC (Alternating Current) driving surface discharge type of plasma display panel and a method of manufacturing the AC driving surface discharge type of plasma display panel.

The present application claims priority of Japanese Patent Application No. 2001-191765 filed on Jun. 25, 2001, which is hereby incorporated by reference.

2. Description of Related Art

FIG. 7 is a perspective exploded view showing a schematic structure of a conventional AC driving surface discharge type of Plasma Display Panel (hereinafter referred to as PDP) 1 in that a part of the front insulation substrate 2 is cut out. FIG. 8 is a top view showing a state in that a front insulation substrate 2 of the PDP 1 is removed. FIG. 9 is an enlarged sectional view showing a section along a line A-A′ in FIG. 8. The PDP 1 is disclosed in Japanese Patent No. 3036496, Japanese Patent Application Laid-open No. Hei 11-202831, and a like.

In the PDP 1, as shown in FIG. 7 to FIG. 9, under the front insulation substrate 2, a plurality of pairs of sustaining electrodes 3a and sustaining electrodes 3b of each extending in a row direction (in a horizontal direction in FIG. 8) are arranged in a column direction (in a vertical direction in FIG. 8) at predetermined intervals so that a discharge gap 4 is put between each pair. The front insulation substrate 2 is made of soda lime glass or a like so as to have a thickness of 2 mm to 5 mm similarly to a back insulation substrate 8 which will be described later. Both of the sustaining electrode 3a and the sustaining electrode 3b are made up of transparent conductive thin films such as tin oxide, indium oxide, and ITO (Indium Tin Oxide) and form a surface discharge electrode pair 3.

A plurality of pairs of bus electrodes 5a and bus electrodes 5b are respectively formed on low surfaces of the plurality of pairs of sustaining electrodes 3a and sustaining electrodes 3b at one side of each end. The bus electrodes 5a and the bus electrodes 5b are made up of metal films such as thick films of silver, or thin films of aluminum or copper and are formed in order to make resistance values of the sustaining electrode 3a and the sustaining electrode 3b of which each electrical conductivity is low. Respective lower faces on which no sustaining electrode 3a and no sustaining electrode 3b and no bus electrode 5a and no bus electrode 5b are formed in the front insulation substrate 2 are covered by a dielectric layer 6 which is transparent. The dielectric layer 6 is made of low melting point glass of which a thickness is 10 μm to 40 μm. A protection layer 7 is formed on the lower face of the dielectric layer 6 in order to protect the dielectric layer 6 from ion impacts during discharge. The protection layer 7 is made of magnesium oxide or a like of which a secondary emission coefficient is large and of which a sputtering-resistance is good, and formed by vacuum deposition or a like so as to have a thickness of 0.5 μm to 2.0 μm.

On the other hand, a plurality of data electrodes 9 in stripe shapes extending in a column direction, namely, in a direction perpendicular to formation direction of the sustaining electrodes 3a and the sustaining electrodes 3b are formed at predetermined intervals. The data electrode 9 is made up of a silver film or a like. Respective upper faces of the data electrodes 9 and the back insulation substrate 8 on which no data electrodes 9 are formed are covered by a white dielectric layer 10. On the dielectric layer 9 except the data electrode 9, a plurality of division walls 13 for separating display cells 12 are formed in the column direction. The display cell 12 is a minimum unit for forming a display screen. In FIG. 8, an area surrounded by a dashed line indicates one of the display cells 12.

Three fluorescent layers 14R, 14G, and 14B for converting an ultraviolet ray which is generated by discharge of a discharge gas into three primary colors of red (R), green (G), and blue (B) of a visible light are formed on the upper face of the dielectric layer 8 on the data electrode 9 and on the side face of the division wall 13. The fluorescent layers 14R, 14G, and 14B are formed in order of the fluorescent layer 14R, the fluorescent layer 14G, and the fluorescent layer 14B sequentially repeatedly in the row direction. The fluorescent layers (not shown) for each converting the ultraviolet ray into a visible light of a same color are formed continuously in the column direction.

Each discharge gas space 15 is kept in each space formed by the lower face of the protection layer 7, each upper face of the fluorescent layers 14R, 14G, and 14B, and two division walls 13 adjacent to each other. The discharge gas space 15 is filled with a discharge gas such as xenon, helium, or neon, or mixed gas thereof under pressure of 20 kPa to 80 kPa. An area including the sustaining electrode 3a and the sustaining electrode 3b, the bus electrode 5a and the bus electrode 5b, the data electrode 9, the fluorescent layers 14R, 14G, and 14B and the discharge gas space 15 makes the display cell 12. When the size of the display cell 12 is 1.05 mm in the vertical direction (column direction) and 0.355 mm in the horizontal direction (row direction), the sustaining electrode 3a and the sustaining electrode 3b of which widths are 300 μm to 500 μm and of which thicknesses are 0.1 μm to 2.0 μm are made so as to have the discharge gap 4 of 50 μm to 300 μm therebetween.

Next, a method of forming the sustaining electrode 3a and the sustaining electrode 3b, and the bus electrode 5a and the bus electrode 5b included in the PDP 1 will be explained with reference to FIG. 10A to FIG. 10E. The sustaining electrode 3a and the sustaining electrode 3b are formed by a lift-off method shown in FIG. 10A to FIG. 10E. FIG. 10A to FIG. 10E are enlarged sectional views showing a side of the front insulation substrate 2 which is enlaged and is turned over up and down in a section along a line A-A′ in FIG. 8. First, as shown in FIG. 10A, a photosensitive dry film 21 is laminated on the front insulation substrate 2. The photosensitive dry film 21 includes a support film (not shown) and photosensitive resin (not shown) formed on the support film. Then, as shown in FIG. 10B, the photosensitive dry film 21 is exposed and developed to pattern the dry film 21. Then, as shown in FIG. 10C, a transparent conductive thin film 22 is formed on the photosensitive dry film 21 which is patterned. Then, as shown in FIG. 10D, the sustaining electrode 3a and the sustaining electrode 3b of predetermined shapes are obtained by removing the photosensitive dry film 21. Then, as shown in FIG. 10E, after pattern printing of silver paste (not shown) is applied onto the sustaining electrode 3a and the sustaining electrode 3b, the bus electrode 5a and the bus electrode 5b of predetermined shapes are obtained by annealing (for example, keeping 560° C. for thirty minutes).

Now, an outline principle in which one display cell 12 emits in the PDP 1 will be explained. First, when a voltage signal for keeping discharge is applied to the sustaining electrode 3a and the sustaining electrode 3b, a discharge generates in the discharge gas space 15. Electrons which generate by this discharge are in collision with xenon atoms, helium atoms, neon atoms, or a like (hereunder, called only xenon atoms or a like), the xenon atoms or a like are excited or ionized. For example, existed xenon atoms generate ultraviolet rays of a vacuum ultraviolet area of 147 nm to 190 nm. The generated ultraviolet rays are irradiated to the fluorescent layer 14R, the fluorescent layer 14G, and the fluorescent layer 14B. The fluorescent layer 14R, the fluorescent layer 14G, and the fluorescent layer 14B to which the ultraviolet rays are irradiated respectively, generate a visible red light, a visible green light, and a visible blue light. The visible red light, the visible green light, and the visible blue are respectively reflected by the white dielectric layer 10, and then go out after passing through the protection layer 7, the dielectric layer 6, the sustaining electrode 3a, the sustaining electrode 3b, and the front insulation substrate 2.

On the other hand, the discharge which generates in the discharge gas space is stopped automatically, after electric charges are accumulated on a lower face of the dielectric layer 6. For example, when a positive pulse voltage is applied to the sustaining electrode 3a and a negative pulse voltage is applied to the sustaining electrode 3b as voltage signal, electrons which generate by the discharge in the discharge gas space 15 move to the sustaining electrode 3a and positive ions such as xenon atoms move to the sustaining electrode 3b. With these processes, the lower face of the dielectric layer 6 formed under the sustaining electrode 3a is negatively charged and the lower face of the dielectric layer 6 formed under the sustaining electrode 3b is positively charged, and then the charge is stopped.

Recently, concerning general displays, also concerning an AC driving surface discharge type of PDP, it is required that an image quality is high and a power consumption is low.

However, in the conventional PDP 1, when a luminance is made high by increasing the voltage to be applied the sustaining electrode 3a and the sustaining electrode 3b in order to improve the image quality, the power consumption caused by the discharge increases.

Then, to carry out a high image quality and a low power consumption, though a first technique to a third technique are considered, new problems occur as follows.

First, to reduce the power consumption of the AC driving surface discharge type of PDP, it is necessary to improve a luminous efficiency of a display cell and to reduce a power consumed by the discharge. Generally, in the AC driving surface discharge type of PDP, as a discharge current density becomes low, a luminous efficiency of ultraviolet rays becomes high. As a result, a luminous efficiency of visible light tends to become high. Then, when a voltage to be applied to a sustaining electrode is reduced and a discharge current is reduced, the discharge current density becomes low. Therefore, it is possible to make a luminous efficiency of a display cell high. However, when the voltage to be applied to the sustaining electrode is reduced, the discharge becomes unstable, and therefore, it is impossible to carry out a stable display operation.

Secondly, when widths of the sustaining electrode 3a and the sustaining electrode 3b are made narrow and areas of the sustaining electrode 3a and the sustaining electrode 3b are reduced, it is possible to reduce a capacitance between the lower face of the dielectric layer 6, and the sustaining electrode 3a and the sustaining electrode 3b. When a voltage applied to the sustaining electrode 3a is equal to a voltage applied to the sustaining electrode 3b, a charge amount accumulated on the lower face of the dielectric layer 6 reduces when the charge is stopped. Therefore, it is possible to reduce a discharge current. However, in the second technique, as described above, since the areas of the sustaining electrode 3a and the sustaining electrode 3b are reduced, the discharge current density of the display cell 12 does not change after all, and therefore, the luminous efficiency hardly changes. Also, when the areas of the sustaining electrode 3a and the sustaining electrode 3b are reduced, the charge does not diffuse in the sustaining electrode 3a and the sustaining electrode 3b over all, and therefore, only a part of the fluorescent layer 14R, the fluorescent layer 14G, and the fluorescent layer 14B emits. As a result, a luminance of the display cell 12 gets worse, and it is impossible to obtain a sufficient image quality.

Thirdly, Japanese Patent Application Laid-open No. Hei 8-22772 discloses a following technique. In this technique, a sustaining electrode made up of a transparent conductive thin film includes a main part extending in a row direction and a projection part projecting from the main part to an adjacent sustaining electrode for each display cell. Then, the projection part has a narrow small part which a width in the row direction is narrower than a width of a top end part in the row direction. In this technique, the narrow small part is provided, whereby the discharge current for one display cell is reduced so as to reduce the power consumption. As a result, the luminous efficiency is improved. However, in this technique, since the discharge concentrates near the small narrow part and does not diffuse in the display cell over all, there is a possibility in that a luminance lowers. Also, in this technique, the sustaining electrode made up of the transparent conductive thin film is patterned in a complex shape, a crack occurs in the small narrow part and there is a possibility of breaking.

### SUMMARY OF THE INVENTION

In view of the above, it is an object of the present invention to provide a plasma display panel and a method of manufacturing the plasma display panel capable of providing both a high image quality and a low power consumption.

According to a first aspect of the present invention, there is provided a plasma display panel having a plurality of surface discharge electrode pairs formed in a column direction at predetermined intervals, each of the surface discharge electrode pairs having a pair of sustaining electrodes extending in a row direction so that a discharge gap is put between the sustaining electrodes, wherein:

each of the sustaining electrodes is made up of a transparent conductive thin film, is provided with a main electrode portion formed in stripe shapes so as to face the discharge gap and a metal film of which a width is narrower than a width of the main electrode portion, and a sub-electrode portion formed at a side opposite to the discharge gap side of the main electrode portion which corresponds.

In the foregoing, a preferable mode is one wherein the sub-electrode portion is provided with a first parallel portion extending in the row direction at a predetermined distance from the main electrode portion, and a second parallel portion extending in the row direction at a predetermined distance from the first parallel portion between the main electrode portion and the first parallel portion.

Also, a preferable mode is one wherein the sub-electrode portion is provided with a vertical portion extending to the main electrode portion at a position at which distances from adjacent division walls extending in the column direction for separating each display cell are approximately equal and integrated with the first parallel portion and the second parallel portion in a manner that an end portion of the vertical portion is electrically in contact with the main electrode portion.

Also, a preferable mode is one wherein the sub-electrode portion is provided with a first vertical portion extending to the main electrode portion at a position at which distances from adjacent division walls extending in the column direction for separating each display cell are approximately equal and integrated with the first parallel portion and the second parallel portion in a manner that an end portion of the vertical portion is electrically in contact with the main electrode portion, and a second vertical portion extending to the main electrode portion in the column direction at an upper side of the division wall and integrated with the first parallel portion and the second parallel portion in a manner that an end portion of the second vertical portion is electrically in contact with the main electrode portion.

Also, a preferable mode is one wherein a width of the second vertical portion is equal to a width of the division wall or is narrower than the width of the division wall.

Also, a preferable mode is one wherein a width of the second vertical portion is a half of a width of the division wall or less.

Also, a preferable mode is one wherein a width of the second parallel portion is 1 μm to 50 μm.

Also, a preferable mode is one wherein a width of the second parallel portion is 1 μm to 30 μm.

Also, a preferable mode is one wherein a width of the first vertical parallel portion is 1 μm to 50 μm.

Also, a preferable mode is one wherein a width of the first vertical parallel portion is 1 μm to 30 μm.

Also, a preferable mode is one wherein the main electrode portion is provided with a main electrode parallel portion extending in the row direction, and a main electrode projection part projecting from the main electrode portion at a side opposite to the discharge gap side of the main electrode portion at a position at which distances from adjacent division wall extending in the column direction to separate each display cell are approximately equal, and the first vertical portion extends to the main electrode portion in the column direction perpendicular to the first parallel portion and the second parallel portion and is integrated with the first parallel portion and the second parallel portion in a manner that an end portion of the first vertical portion is electrically in contact with the main electrode portion which corresponds.

Also, a preferable mode is one wherein lengths of the main electrode projection part in the row direction and in the column direction are 30 μm to 60 μm.

Also, a preferable mode is one wherein the sub-electrode portion is provided with a first parallel portion extending in the row direction at a predetermined distance from the main electrode portion, a first vertical portion extending to the main electrode portion in the column direction over each division wall extending in the column direction so as to separate each display cell and integrated with the first parallel portion in a manner that an end portion of the first vertical portion is electrically in contact with the main electrode portion, and a cross part including a second vertical portion extending to the main electrode portion in the column direction at a position at which distances from adjacent division walls are approximately equal and an end portion of the second vertical portion reaching near a side face of the main electrode portion, and second parallel portions respectively extending from an approximate center to the first vertical portions which are adjacent in a manner that an end portion of each of the second parallel portions reaches near the first vertical portions which are adjacent, the cross part integrated with the first vertical portion.

Also, a preferable mode is one wherein a width of the first vertical portion is equal to a width of the division wall or is narrower than a width of the division wall.

Also, a preferable mode is one wherein a width of the first vertical portion is a half of a width of the division wall or less.

Also, a preferable mode is one further including:

a bus electrode portion including a bus electrode parallel portion extending in the row direction in parallel with the first parallel portion at a distance at which there is no influence from the first parallel portion, and a bus electrode vertical portion extending to the first parallel portion in the column direction perpendicular to the first parallel portion and the bus parallel portion in a manner that an end portion of the bus electrode vertical portion is electrically in contact with the first parallel portion, and the bus electrode portion is integrated with the sub-electrode portion.

Also, a preferable mode is one wherein a width of the main electrode portion is 30 μm to 100 μm.

Also, a preferable mode is one wherein a width of the main electrode portion is 40 μm to 80 μm.

Also, a preferable mode is one wherein widths of the first parallel portion and the second parallel portion are 30 μm to 100 μm.

Also, a preferable mode is one wherein widths of the first parallel portion and the second parallel portion are 40 μm to 80 μm.

Also, a preferable mode is one wherein a width of the first parallel portion is 30 μm to 60 μm.

Furthermore, a preferable mode is one wherein both of an interval between the main electrode portion and the first parallel portion, and an interval between the second parallel portion and the first parallel portion are 30 μm to 140 μm.

According to a second aspect of the present invention, there is provided a method of manufacturing a plasma display panel according to the first aspect, a method including:

a first step of coating photosensitive silver paste on a front insulation substrate or a front insulation substrate after forming a plurality of surface discharge pair; and

a second step of forming a sub-electrode portion by annealing after exposing and developing the photosensitive silver paste and patterning the photosensitive silver paste.

According to a third aspect of the present invention, there is provided a method of manufacturing a plasma display panel according to the first aspect, a method including:

a first step of coating silver paste on a front insulation substrate or a front insulation substrate after forming a plurality of surface discharge pair; and

a second step of forming the sub-electrode portion by annealing after patterning the silver paste.

With this configuration, it is possible to obtain a high image quality high and to reduce power consumption.

### BRIEF DESCRIPTION OF THE DRAWINGS

The above and other objects, advantages, and features of the present invention will be more apparent from the following description taken in conjunction with the accompanying drawings in which:

FIG. 1 is a top view showing an AC driving surface discharge type of PDP 31 in that a front insulation substrate 32 is not shown, according to a first embodiment of the present invention;

FIG. 2A to FIG. 2F are process views for explaining a forming method of a sustaining electrode 33a and a sustaining electrode 33b of the PDP 31;

FIG. 3 is a top view showing an AC driving surface discharge type of PDP 51 in that a front insulation substrate 52 is not shown, according to a second embodiment of the present invention;

FIG. 4 is a top view showing an AC driving surface discharge type of PDP 61 in that a front insulation substrate 62 is not shown, according to a third embodiment of the present invention;

FIG. 5 is a top view showing an AC driving surface discharge type of PDP 81 in that a front insulation substrate 82 is not shown according to a fourth embodiment of the present invention;

FIG. 6 is a top view showing an AC driving surface discharge type of PDP 91 in that a front insulation substrate 92 is not shown, according to a fifth embodiment of the present invention;

FIG. 7 is a perspective exploded view showing a schematic structure of a conventional AC driving surface discharge type of PDP 1 in that a part of a front insulation substrate 2 is cut out;

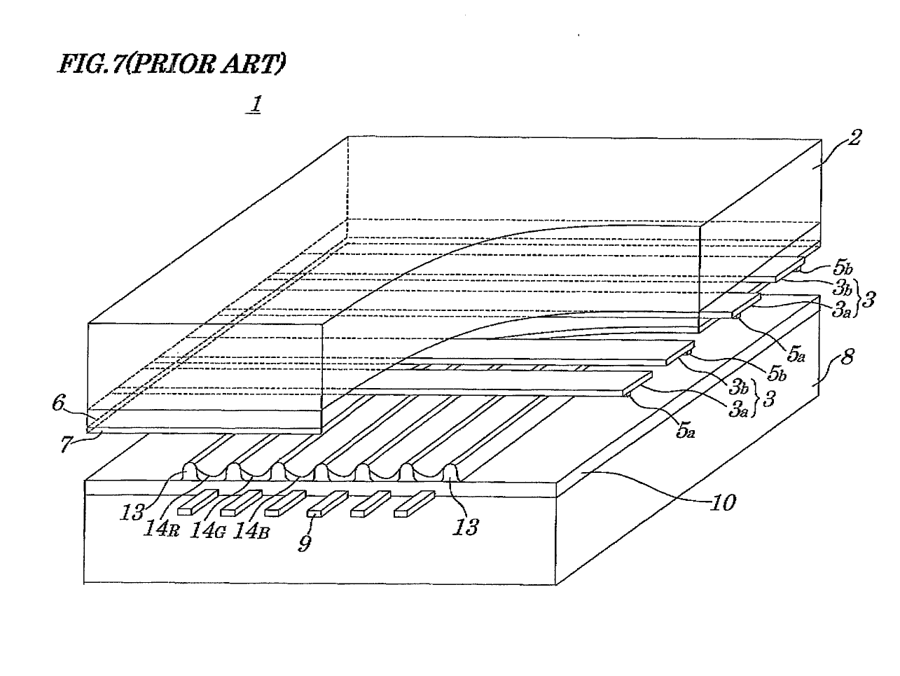

FIG. 8 is a top view showing the conventional AC driving surface discharge type of PDP 1 in that the front insulation substrate 2 is not shown;

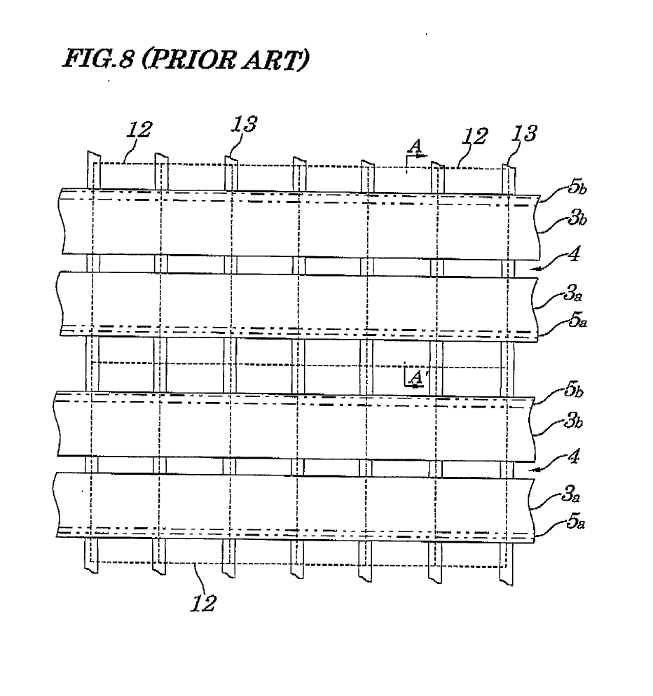

FIG. 9 is an enlarged sectional view showing a section taken along a line A-A′ in FIG. 8; and

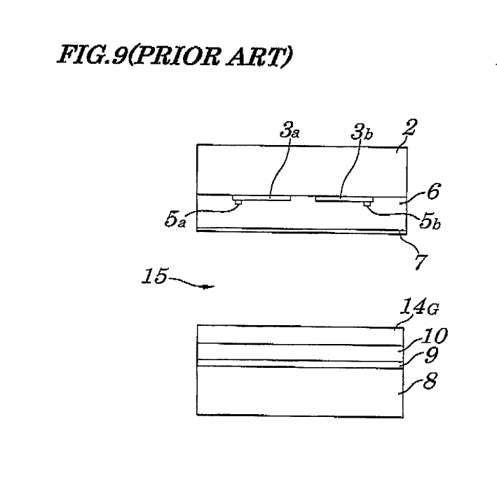

FIG. 10A to FIG. 10E are conventional process views for explaining a method of forming a sustaining electrode 3a, a sustaining electrode 3b, a bus electrode 5a, and a bus electrode 5b of the PDP 1.

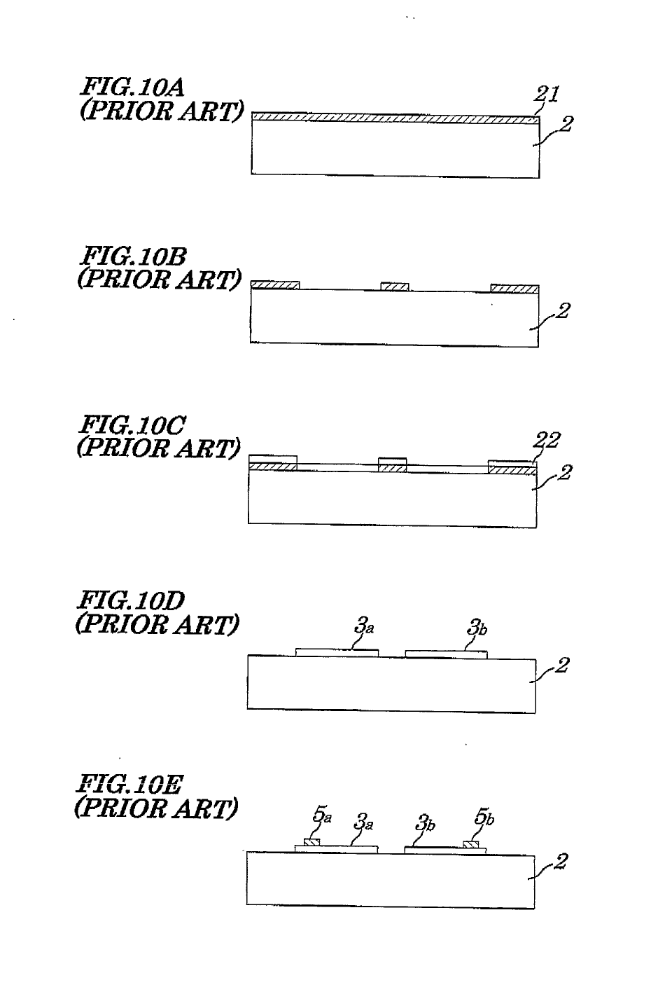

### DETAILED DESCRIPTION OF THE PREFERRED EMBODIMENTS

Best modes for carrying out the present invention will be described in further detail using embodiments with reference to the accompanying drawings.

### First Embodiment

A first embodiment of the present invention will be described.

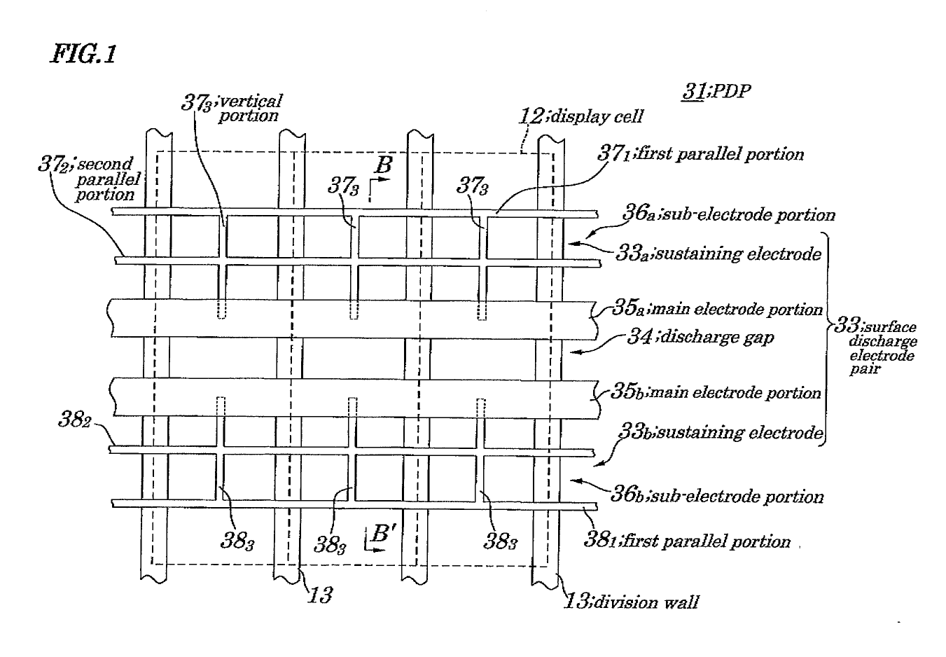

FIG. 1 is a top view showing an AC driving surface discharge type of PDP 31 in that a front insulation substrate 32 is not shown, according to a first embodiment of the present invention.

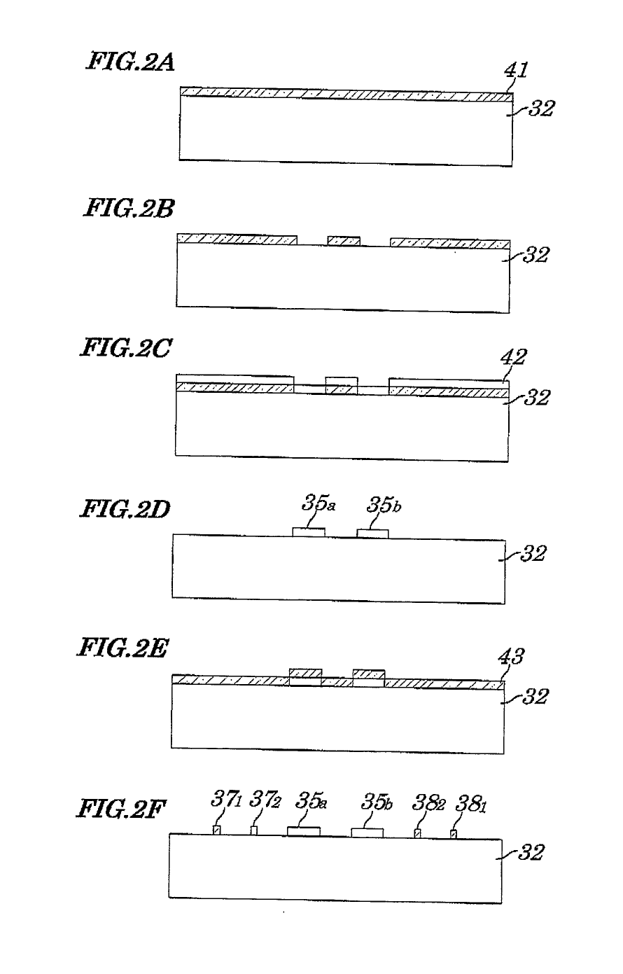

In the PDP 31, under the front insulation substrate 32, as shown in FIG. 1, a plurality of pairs of sustaining electrodes 33a and sustaining electrodes 33b extending in a row direction (in a horizontal direction in FIG. 1) as whole are alternately arranged in a column direction (in a vertical direction in FIG. 1) at predetermined intervals so that a discharge gap 34 is put between each pair. The front insulation substrate 32 (shown in FIGS. 2A-2F) is made of soda lime glass or a like so as to have a thickness of 2 mm to 5 mm. The sustaining electrode 33a and the sustaining electrode 33b form a surface discharge electrode pair 33. The sustaining electrode 33a includes a main electrode portion 35a and a sub-electrode portion 36a. Similarly, the sustaining electrode 33b includes a main electrode portion 35b and a sub-electrode portion 36b.

Both of the main electrode portion 35a and the main electrode portion 35b are made up of transparent conductive thin films in stripe shapes such as tin oxide, indium oxide, or ITO (Indium Tin Oxide). Widths of the main electrode portion 35a and the main electrode portion 35b are 30 from μm to 100 μm, preferably, from 40 μm to 80 μm.

A plurality of pairs of the sub-electrode portion 36a and the sub-electrode portion 36b are respectively formed on lower faces of the plurality of pair of the main electrode portion 35a and the main electrode portion 35b so as to correspond to the main electrode portion 35a and the main electrode portion 35b. The main electrode portion 35a is made up of metal films such as thick films of silver, or thin films of aluminum or copper and are provided with a first parallel portion 37₁, a second parallel portion 37₂, and a plurality of vertical portions 37₃ formed for respective display cells 12. The first parallel portion 37₁ is formed in parallel with the main electrode portion 35a at a predetermined distance from the main electrode portion 35a so as to extend in the row direction. The second parallel portion 37₂ is formed in parallel with the main electrode portion 35a at a predetermined distance from the main electrode portion 35a between the main electrode portion 35a and the first parallel portion 37₁ so as to extend in the row direction. Each vertical portion 37₃ is integrated with the first parallel portion 37₁ and the second parallel portion 37₂, and extends to the main electrode portion 35a in the column direction perpendicular to the first parallel portion 37₁ and the second parallel portion 37₂, and an upper face of each vertical portion 37₃ is electrically in contact with a lower face of the main electrode portion 35a. Each vertical portion 37₃ is formed over a position at which distances from adjacent division walls 13 in the display cell 12 in an area surrounded by a dashed line in FIG. 1 are approximately equal. Similarly, the sub-electrode portion 36b is made up of metal films such as thick films of silver, or thin films of aluminum or copper and are provided with a first parallel portion 38₁, a second parallel portion 38₂, and a plurality of vertical portions 38₃ formed for respective display cells 12. The sub-electrode portion 36a and the sub-electrode portion 36b are in a line-ymmetric relationship in which a center axis of the discharge gap 34 is used as a symmetry line, and therefore, no detailed explanations of the sub-electrode portion 36b will be given.

Widths of the first parallel portion 38₁ and the second parallel portion 38₂ are preferably 30 μm to 60 μm to reduce resistance values of the main electrode portion 35a and the main electrode portion 35b of which conductivity is low. In other words, the first parallel portion 37₁ and the first parallel portion 38₁ function similarly to conventional bus electrodes. Widths of the second parallel portion 37₂ and the second parallel portion 38₂, and widths of the vertical portion 37₃ and the vertical portion 38₃ are 1 μm to 50 μm, preferably, 1 μm to 30 μm. In the first embodiment, both of an interval between the main electrode portion 35a and the second parallel portion 37₂, and an interval between the second parallel portion 37₂ and the first parallel portion 37₁ are 30 μm to 140 μm. Similarly, both of an interval between the main electrode portion 35b and the second parallel portion 38₂, and an interval between the second parallel portion 38₂ and the first parallel portion 38₁ are 30 μm to 140 μm.

Additionally, the main electrode portion 35a and the main electrode portion 35b, the sub-electrode portion 36a and the sub-electrode portion 36b, and a dielectric layer (not shown) and a protection layer (not shown) which may be sequentially formed on a lower face of the front insulation substrate 32 (shown in FIGS. 2A-2F) on which no main electrode portion 35a and no main electrode portion 35b, and no sub-electrode portion 36a and no sub-electrode portion 36b are formed are similar to those of a conventional PDP, and therefore, no explanations of those will be given. Also, a data electrode, a dielectric layer, a division wall, three kinds of fluorescent layers, and discharge gas to be filled up in a discharge gas space are similar to those of the conventional PDP, and therefore, no explanations of those will be given.

Next, a method of forming the sustaining electrode 33a and the sustaining electrode 33b included in the PDP 31 will be explained with reference to FIG. 2A to FIG. 2F. The main electrode portion 35a and the main electrode portion 35b are formed by a lift-off method shown in FIG. 2A to FIG. 2F. FIG. 2A to FIG. 2F are enlarged sectional views showing a side of the front insulation substrate 32 which is enlarged and is turned over up and down in a section along a line B-B′ in FIG. 1. First, as shown in FIG. 2A, a photosensitive dry film 41 is formed on the front insulation substrate 32. The photosensitive dry film 41 includes a support film (not shown) and photosensitive resin (not shown) formed on the support film. Then, as shown in FIG. 28, the photosensitive dry film 41 is exposed and developed to pattern the photosensitive dry film 41.

Then, as shown in FIG. 2C, a transparent conductive thin film 42 is formed on the photosensitive dry film 41 which is patterned. Then, as shown in FIG. 2D, the main electrode portion 35a and the main electrode portion 35b of predetermined shapes are obtained by removing the photosensitive dry film 41. Then, as shown in FIG. 2E, photosensitive silver paste 43 is coated on the front insulation substrate 32 with the main electrode portion 35a and the main electrode portion 35b. Then, as shown in FIG. 2F, the photosensitive silver paste 43 is exposed and developed, the photosensitive silver paste 43 is patterned, and then annealing is performed (for example, keeping at 550° C. for ten minutes), whereby the sub-electrode portion 36a (shown in FIG. 1) first parallel portion 37₁, the second parallel portion 37₂ and the vertical portion 37₃, and the sub-electrode portion 36b including the first parallel portion 38₁, the second parallel portion 38₂ and the vertical portion 38₃ are formed. Sheet resistances of the sub-electrode portion 36a and the sub-electrode portion 36b which were formed under a above-mentioned annealing condition were 3 mΩ/□ to 4 mΩ/□. Here, the vertical portion 37₃ and the vertical portion 37₄ are not shown in FIG. 2F.

As described above, according to the first embodiment, since the main electrode portion 35a and the main electrode portion 35b in stripe shapes are formed so as to extend in the row direction at both sides of the discharge gap 34, discharge becomes stable and a discharge voltage can be reduced. Also, since the main electrode portion 35a and the main electrode portion 35b are made from transparent conductive thin films, a strong light near the discharge gap 34 can pass through, and a high luminance display can be obtained. According to an experiment, widths of the main electrode portion 35a and the main electrode portion 35b were set to 30 μm to 100 μm, a high luminance display was obtained with stability of the discharge, Particularly, when the widths of the main electrode portion 35a and the main electrode portion 35b were set to 40 μm to 80 μm, it was possible to reduce the discharge voltage and to obtain a high luminance display.

Also, the second parallel portion 37₂ and the vertical portion 37₃ are formed between the main electrode portion 35a and the first parallel portion 37₁, and the second parallel portion 38₂ and the vertical portion 38₃ are formed between the main electrode portion 35b and the first parallel portion 38₁. The second parallel portion 37₂ and the second parallel portion 38₂, and the vertical portion 37₃ and the vertical portion 38₃ are made up of metal films and have a thickness of 1 μm to 50 μm. Therefore, according to the structure in the first embodiment, improvement of 10% to 40% of the luminous efficiency of the display cell 12 is caused by the following reasons.

As described above, generally, in an AC driving surface discharge type of PDP, as discharge current density is low, the luminous efficiency of the ultraviolet rays is high. As a result, the luminous efficiency of the visible light tends to be high. In the first embodiment, the widths of the second parallel portion 37₂ and the second parallel portion 38₂, and the widths of the vertical portion 37₃ and the vertical portion 38₃, are set to 1 μm to 50 μm, and an aperture is provided for each area between electrode portions forming the sub-electrode portion 36a and the sub-electrode portion 36b, whereby the discharge current density is controlled so as not to be high in those areas. As described above, the discharge current density is controlled, and this may be the reason why that the luminous efficiency of the display cell 12 can be improved. The metal film intercepts the visible light, whereas widths of the second parallel portion 37₂ and the second parallel portion 38₂, and the widths of the vertical portion 37₃ and the vertical portion 38₃ are 1 μm to 50 μm. Then, an amount of intercepted visible light is extremely smaller than the whole amount of visible light, and therefore, it does not achieve an amount to influence on the luminance.

According to an experiment, when the widths of the second parallel portion 37₂ and the second parallel portion 38₂, and the width of the vertical portion 37₃ and the vertical portion 38₃ were set to 1 μm to 30 μm, a high luminance display could be obtained. Also, in the structure of the first embodiment, as the voltage to be applied to the sustaining electrode 33a and the sustaining electrode 33b is not reduced, there does not occur danger that the discharge described as the first problem in Description of Related Art becomes unstable and a stable display operation cannot be performed.

Also, according to the structure of the first embodiment, the second parallel portion 37₂ and the second parallel portion 38₂, and the vertical portion 37₃ and the vertical portion 38₃ are provided, and the widths of them are set to 1 μm to 50 μm. Also, there is no case in that areas of the main electrode portion 35a and the main electrode portion 35b are reduced, the shapes of the main electrode portion 35a and the main electrode portion 35b are stripes, and no projection part disclosed in Japanese Patent Application Laid-open No. Hei 8-22772 is provided. According to this structure, the discharge current density is controlled, and the discharge diffuses all over the sustaining electrode 33a and the sustaining electrode 33b. With this structure, since it is possible to excite all of a fluorescent layer 14R, the fluorescent layer 14G, and a fluorescent layer 14B by ultraviolet rays, a luminance of the display cell 12 becomes higher, and a sufficient image quality can be obtained.

Therefore, according to the structure of the first embodiment, it is possible to make a higher image quality and to reduce the consumption power.

Also, according to the structure of the first embodiment, the photosensitive silver paste 43 is exposed and developed, and is patterned, and then, annealing is performed. Then, the sub-electrode portion 36a including the first parallel portion 37₁, the second parallel portion 37₂, and the vertical portion 37₃, and the sub-electrode portion 36b including the first parallel portion 38₁, the second parallel portion 38₂, and the vertical portion 38₃, which require a high patterning accuracy, are formed. Therefore, in comparison with the conventional technique in which the solution in the exposure is influenced by a thickness of a film, and the transparent conductive film is patterned by using a photosensitive dry film having an insufficient patterning accuracy, it is possible to form the sub-electrode 36a and the sub-electrode 36b easily with a good patterning accuracy.

On the other hand, according to the structure of the first embodiment, the main electrode portion 35a and the main electrode portion 35b are patterned by using a photosensitive dry film of which a process cost is cheaper. However, since the widths of the main electrode portion 35a and the main electrode portion 35b are 30 μm to 100 μm, a patterning accuracy is rougher than that of the sub-electrode 36a and the sub-electrode 36b, and therefore, it is possible to pattern the main electrode portion 35a and the main electrode portion 35b cheaply and easily.

Also, according to the structure of the first embodiment, since the sub-electrode portion 36a and the sub-electrode portion 36b are made from a metal film, it is hard to occur a crack at a joint point of the main electrode portion 35a and the vertical portion 37₃ or at an intersection of the first parallel portion 37₁ and the vertical portion 37₃ and it is hard to break a wire.

### Second Embodiment

A second embodiment of the present invention will be described.

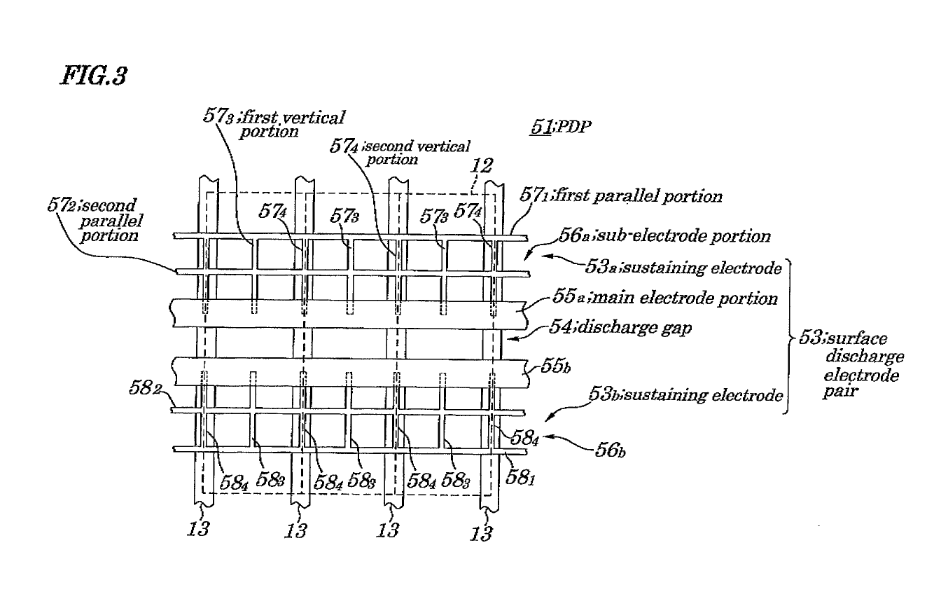

FIG. 3 is a top view showing an AC driving surface discharge type of PDP 51 in that a front insulation substrate 52 is not shown, according to a second embodiment of the present invention.

In the PDP 51, under the front insulation substrate 52 (not shown), as shown in FIG. 3, a plurality of pairs of sustaining electrodes 53a and sustaining electrodes 53b extending in a row direction (in a horizontal direction in FIG. 3) as whole are alternately arranged in a column direction (in a vertical direction in FIG. 3) at predetermined intervals so that a discharge gap 54 is put between each pair. The front insulation substrate 52 is made of soda lime glass or a like so as to have a thickness of 2 mm to 5 mm. The sustaining electrode 53a and the sustaining electrode 53b form a surface discharge electrode pair 53. The sustaining electrode 53a includes a main electrode portion 55a and a sub-electrode portion 56a. Similarly, the sustaining electrode 53b includes a main electrode portion 55b and a sub-electrode portion 56b.

Both of the main electrode portion 55a and the main electrode portion 55b are made up of transparent conductive thin films in stripe shapes such as tin oxide, indium oxide, or ITO (Indium Tin Oxide). Widths of the main electrode portion 55a and the main electrode portion 55b are 30 μm to 100 μm, preferably 40 μm to 80 μm.

A plurality of pairs of the sub-electrode portion 56a and the sub-electrode portion 56b are respectively formed on lower faces of the plurality of pairs of the main electrode portion 55a and the main electrode portion 55b so as to correspond the main electrode portion 55a and the main electrode portion 55b. The main electrode portion 55a is made up of metal films such as thick films of silver, or thin films of aluminum or copper and are provided with a first parallel portion 57₁, a second parallel portion 57₂, a plurality of first vertical portions 57₃ formed for respective display cells 12, and a plurality of second vertical portions 57₄ provided over a division wall 13. The first parallel portion 57₁ is formed in parallel with the main electrode portion 55a at a predetermined distance from the main electrode portion 55a so as to extend in the row direction. The second parallel portion 57₂ is formed in parallel with the main electrode portion 55a at a predetermined distance from the main electrode 55a between the main electrode portion 55a and the first parallel portion 57₁ so as to extend in the row direction. Each first vertical portion 57₃ is integrated with the first parallel portion 57₁ and the second parallel portion 57₂, and extends to the main electrode portion 55a in the column direction perpendicular to the first parallel portion 57₁ and the second parallel portion 57₂, and an upper face of each first vertical portion 57₃ is electrically in contact with a lower face of the main electrode portion 55a. Each first vertical portion 57₃ is formed over a position at which distances from an adjacent division wall 13 in the display cell 12 in an area surrounded by a dashed line in FIG. 3 are approximately equal Each second vertical portion 57₄ is integrated with the first parallel portion 57₁ and the second parallel portion 57₂, and extends to the main electrode portion 55a in the column direction perpendicular to the first parallel portion 57₁ and the second parallel portion 57₂, and an upper face of an end portion of each second vertical portion 57₄ is electrically in contact with a lower face of the main electrode portion 55a. Also, each second vertical portion 57₄ is formed over the division wall 13 with a length approximately similar to that of the first vertical portion 57₃ which is adjacent. Similarly, the sub-electrode portion 56b is made up of metal films such as thick films of silver, or thin films of aluminum or copper and are provided with a first parallel portion 58₁, a second parallel portion 58₂, a plurality of first vertical portions 58₃ formed for respective display cells 12, and a plurality of second vertical portions 58₄ provided over the division wall 13. The sub-electrode portion 56a and the sub-electrode portion 56b are in a line-ymmetric relationship in which a center axis of the discharge gap 54 is used as a symmetry line, and therefore, no detailed explanations of the sub-electrode portion 56b will given.

Widths of the first parallel portion 58₁ and the second parallel portion 58₂ are preferably 30 μm to 60 μm to reduce resistance values of the main electrode portion 55a and the main electrode portion 55b of which each conductivity is low. In other words, the first parallel portion 57₁ and the first parallel portion 58₁ function similarly to conventional bus electrodes. Widths of the second parallel portion 57₂ and the second parallel portion 58₂, widths of the first vertical portion 57₃ and the first vertical portion 58₃, and widths of the second vertical portion 57₄ and the second vertical portion 58₄ are 1 μm to 50 μm, preferably, 1 μm to 30 μm. In the second embodiment, both of an interval between the main electrode portion 55a and the second parallel portion 57₂, and an interval between the second parallel portion 57₂ and the first parallel portion 57₁ are 30 μm to 140 μm, Similarly, both of an interval between the main electrode portion 55b and the second parallel portion 58₂, and an interval between the second parallel portion 58₂ and the first parallel portion 58₁ are 30 μm to 140 μm. It is preferable that the widths of the second vertical portion 57₄ and the second vertical portion 58₄ are equal to a width of the division wall 13 or narrower than the width of the division wall 13 from a point of the luminous efficiency and the luminance.

Additionally, the main electrode portion 55a and the main electrode portion 55b, the sub-electrode portion 56a and the sub-electrode portion 56b, and a dielectric layer (not shown) and a protection layer (not shown) which may be sequentially formed on a lower face of the front insulation substrate 52 (not shown) on which no main electrode portion 55a and no main electrode portion 55b, and no sub-electrode portion 55a and no sub-electrode portion 56b are formed are similar to those of a conventional PDP, and therefore, no explanations of those will be given. Also, a data electrode, a dielectric layer, a division wall, and three kinds of fluorescent layers (all not shown) which are sequentially formed on the back insulation substrate, and discharge gas to be filled up in a discharge gas space are similar to those of the conventional PDP, and therefore, no explanations of those will be given. Also, a method of forming the sustaining electrode 53a and the sustaining electrode 53b included in the PDP 51 is approximately similar to that of the first embodiment except that a pattern shape in patterning of a photosensitive silver paste 43 (not shown) since shapes of the sub-electrode portion 56a and the sub-electrode portion 56b are different from those of a sub-electrode portion 36a and a sub-electrode portion 36b . Therefore, no explanations of the method will be given.

As described above, with the second embodiment, the second vertical portion 57₄ and the second vertical portion 58₄ are over the division wall 13. In addition to the effects obtained by the first embodiment, the following effects can be obtained. Since the second vertical portion 57₄ and the second vertical portion 58₄ are over the division wall 13, the discharge diffuses near the division wall 13, xenon atoms or a like excited by the discharge generate ultraviolet rays, the generated ultraviolet rays are irradiated to side walls (not shown) of the division wall 13 and to a fluorescent layer 14R, a fluorescent layer 14G, and a fluorescent layer 14B (all not shown) which are formed near the side walls. With this structure, it is possible to make the luminance of the display cell 12 higher than that of the first embodiment.

As described above, from points of luminous efficiency and luminance, it is preferable that the widths of the second vertical portion 57₄ and the second vertical portion 58₄ are equal to that of the division wall 13 or narrower. The width of the division wall 13 varies at a bottom and a top. Here, the width of the division wall 13 indicates the top width of the division wall 13. Hereunder, the width of the division wall 13 also indicates the top width.

On the other hand, from points of manufacturing, it is preferable that the widths of the second vertical portion 57₄ and the second vertical portion 58₄ are a half of that of the division wall 13 or less. The reasons will be described. Distortions generate in the front insulation substrate (not shown) and the back insulation substrate (not shown) in a annealing process after forming the sustaining electrode 53a and the sustaining electrode 53b. Therefore, when the front insulation substrate and the back insulation substrate are put together, there is a possibility in that a positional relationship between the front insulation substrate and the back insulation substrate displaces. When a displacement occurs, and the second vertical portion 57₄ and the second vertical portion 58₄ are formed not over the division wall 13 though the second vertical portion 57₄ and the second vertical portion 58₄ must be formed over the division wall 13, the discharge state changes, and a characteristic changes for every PDP 51. Also, in a case of the displacement, when a strong discharge generates near the division wall 13, the xenon atoms or a like excited by the discharge do not generate ultraviolet rays efficiently, and therefore, the luminous efficiency lowers. Then, the widths of the second vertical portion 57₄ and the second vertical portion 58₄ are a half of the division wall 13 or less. Therefore, though a displacement of the front insulation substrate and the back insulation substrate occurs, there is no case in that the the widths of the second vertical portion 57₄ and the second vertical portion 58₄ displace from the division wall 13 if only the displacement is in the half of the division wall 13 in the row direction. With this structure, it is possible to reduce the influences caused by the displacement.

### Third Embodiment

A third embodiment of the present invention will be described.

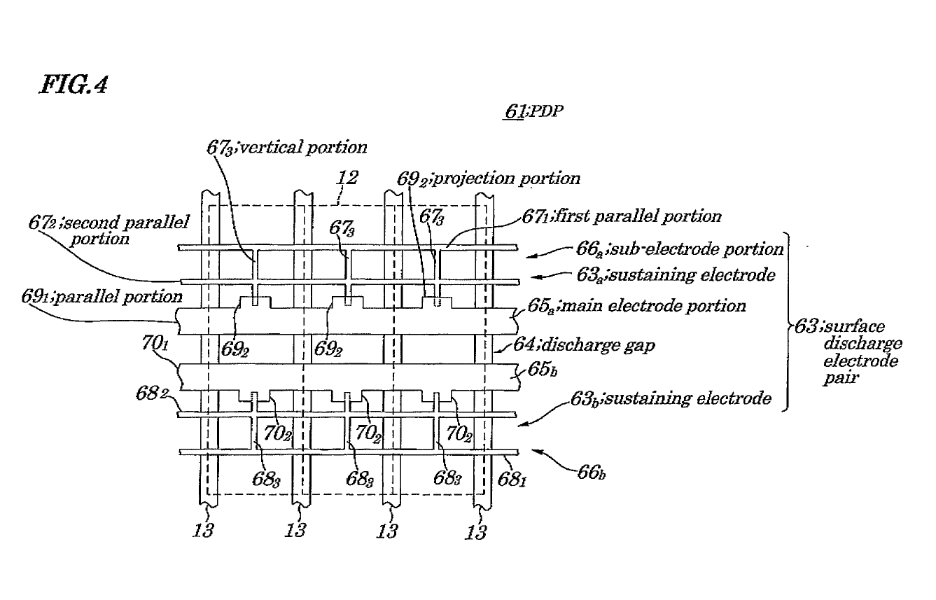

FIG. 4 is a top view showing an AC driving surface discharge type of PDP 61 in that a front insulation substrate 62 is not shown, according to a third embodiment of the present invention.

In the PDP 61, under the front insulation substrate 62 (not shown), as shown in FIG. 4, a plurality of pairs of sustaining electrodes 63a and sustaining electrodes 63b extending in a row direction (in a horizontal direction in FIG. 4) as whole are alternately arranged in a column direction (in a vertical direction in FIG. 4) at predetermined intervals so that a discharge gap 64 is put between each pair. The front insulation substrate 62 is made of soda lime glass or a like so as to have a thickness of 2 mm to 5 mm. The sustaining electrode 63a and the sustaining electrode 63b form a surface discharge electrode pair 63. The sustaining electrode 63a includes a main electrode portion 65a and a sub-electrode portion 66a. Similarly, the sustaining electrode 63b includes a main electrode portion 65b and a sub-electrode portion 66b.

Both of the main electrode portion 65a and the main electrode portion 65b are made up of transparent conductive thin films in stripe shapes such as tin oxide, indium oxide, or ITO (Indium Tin Oxide). The main electrode portion 65a includes a parallel portion 69₁, and projection parts 69₂, and the main electrode portion 65b includes a parallel portion 70₁, and projection parts 70₂. The parallel portion 69₁ and the parallel portion 70₁ are formed so as to extend in the row direction, and widths of the parallel portion 69₁ and the parallel portion 70₁ are 30 μm to 100 μm, preferably, 40 μm to 80 μm. The projection parts 69₂ are formed at an upper position at which distances from adjacent division walls 13 in the display cell 12 shown as a area surrounded by a dashed line in FIG. 4 are approximately equal and are formed so as to project from the parallel portion 69₁ at a side opposite to a side facing the discharge gap 64. Similarly, the projection parts 70₂ are formed at an upper position at which distances from adjacent division walls 13 in the display cell 12 shown as a area surrounded by a dashed line in FIG. 4 are approximately equal and is formed so as to project from the parallel portion 70₁ at a side opposite to a side facing the discharge gap 64. As to shapes of the projection parts 69₂ and the projection parts 70₂, both lengths in the row direction and in the column direction are set to 30 μm to 60 μm, for example, 50 μm. Under this condition, it is possible to obtain sufficient electrical contact of the projection parts 69₂ and the projection parts 70₂, and a vertical portion 68₃ and the vertical portion 70₃ which will be described. Additionally, though the main electrode portion 65a and the main electrode portion 65b are provided with the projection parts 69₂ and the projection parts 70₂, it is possible to obtain a yield equal to the first embodiment in which a main substrate 35a (shown in FIG. 1) and a main substrate 35b (shown in FIG. 1) stripe shapes are patterned.

A plurality of pairs of the sub-electrode portion 66a and the sub-electrode portion 66b are respectively formed on lower faces of the plurality of pairs of the main electrode portions 65a and the main electrode portions 65b so as to correspond the main electrode portions 65a and the main electrode portions 65b. The sub-electrode portion 66a is made up of metal films such as thick films of silver, or thin films of aluminum or copper and are provided with a first parallel portion 67₁, a second parallel portion 67₂, and a plurality of vertical portions 67₃ formed for respective display cells 12. The first parallel portion 67₁ is formed in parallel with the main electrode portion 65a at a predetermined distance from the main electrode portion 65a so as to extend in the row direction. The second parallel portion 67₂ is formed in parallel with the main electrode portion 65a at a predetermined distance from the main electrode portion 65a between the main electrode portion 65a and the first parallel portion 67₁ so as to extend in the row direction. Each vertical portion 67₃ is integrated with the first parallel portion 67₁ and the second parallel portion 67₂, and extends to the main electrode portion 65a in the column direction perpendicular to the first parallel portion 67₁ and the second parallel portion 67₂, and an upper face of an end portion of each vertical portion 67₃ is electrically in contact with a lower face of the projection part 69₂. Each vertical portion 67₃ is formed over a position at which distances from adjacent division wall 13 in the display cell 12 in an area surrounded by a dashed line in FIG. 4 are approximately equal. Similarly, the sub-electrode portion 66b is made up of metal films such as thick films of silver, or thin films of aluminum or copper and are provided with a first parallel portion 68₁, a second parallel portion 68₂, and the plurality of vertical portions 68₃ formed for respective display cells 12. The sub-electrode portion 66a and the sub-electrode portion 66b are in a line-ymmetric relationship in which a center axis of the discharge gap 64 is used as a symmetry line, and therefore, no detailed explanations of the sub-electrode portion 66a will given.

Widths of the first parallel portion 67₁ and the first parallel portion 68₂ are preferably 30 μm to 60 μm to reduce resistance values of the main electrode portion 65a and the main electrode portion 65b of which conductivity is low. In other words, the first parallel portion 67₁ and the first parallel portion 68₁ function similarly to conventional bus electrodes. Widths of the second parallel portion 67₂ and the second parallel portion 68₂, and widths of the vertical portion 67₃ and the vertical portion 68₃ are 1 μm to 50 μm, preferably, 1 μm to 30 μm. In the third embodiment, both of an interval between the parallel portion 69₁ of the main electrode portion 65a and the second parallel portion 67₂, and an interval between the second parallel portion 67₂ and the first parallel portion 67₁ are 30 μm to 140 μm. Similarly, both of an interval between the parallel portion 70₁ of the main electrode portion 65b and the second parallel portion 68₂ and an interval between the second parallel portion 68₂ and the first parallel portion 68₁ are 30 μm to 140 μm.

Additionally, the main electrode portion 65a and the main electrode portion 65b, the sub-electrode portion 66a and the sub-electrode portion 66b, and a dielectric layer (not shown) and a protection layer (not shown) which may be sequentially formed on a lower face of the front insulation substrate 62 (not shown) on which no main electrode portion 65a and no main electrode portion 65b, and no sub-electrode portion 66a and no sub-electrode portion 66b are formed are similar to those of the conventional PDP, and therefore, no explanations of those will be given. Also, a data electrode, a dielectric layer, a division wall, and three kinds of fluorescent layers (all not shown) which are sequentially formed on the back insulation substrate, and discharge gas to be filled up in a discharge gas space are similar to those of the conventional PDP, and therefore, no explanations of those will be given. Also, a method of forming the sustaining electrode 63a and the sustaining electrode 63b included in the PDP 61 is approximately similar to that of the first embodiment except that a pattern shape in patterning of a photosensitive dry film 41 (shown in FIG. 2A) and a photosensitive silver paste 43 (shown in FIG. 2E) since shapes of the main electrode portion 65a and the main electrode 65b, and the sub-electrode portion 66a and the sub-electrode portion 66b are different from those of a main electrode portion 35a (shown in FIG. 1) and a main electrode portion 35b (shown in FIG. 1) and a sub-electrode portion 36a (shown in FIG. 1) and a sub-electrode portion 36b (shown in FIG. 1). Therefore, no explanations of the method will be given.

As described above, with the third embodiment, the main electrode portion 65a is provided with a projection part 69₂, and each top of the vertical portion 67₃ forming the sub-electrode portion 66a made from the metal film is electrically in contact with only the lower face of the corresponding projection part 69₂. Similarly, the main electrode portion 65b is provided with the projection part 70₂, and each top of the vertical portion 68₃ forming the sub-electrode portion 66b made from the metal film is electrically in contact with only the lower face of the corresponding projection part 70₂. Therefore, according to the structure of the third embodiment, since it is possible to reduce an area of the metal film which is not transparent and intercepts visible light, it is possible to make luminance higher and to improve luminous efficiency in comparison with the first embodiment.

### Fourth Embodiment

A fourth embodiment of the present invention will be described.

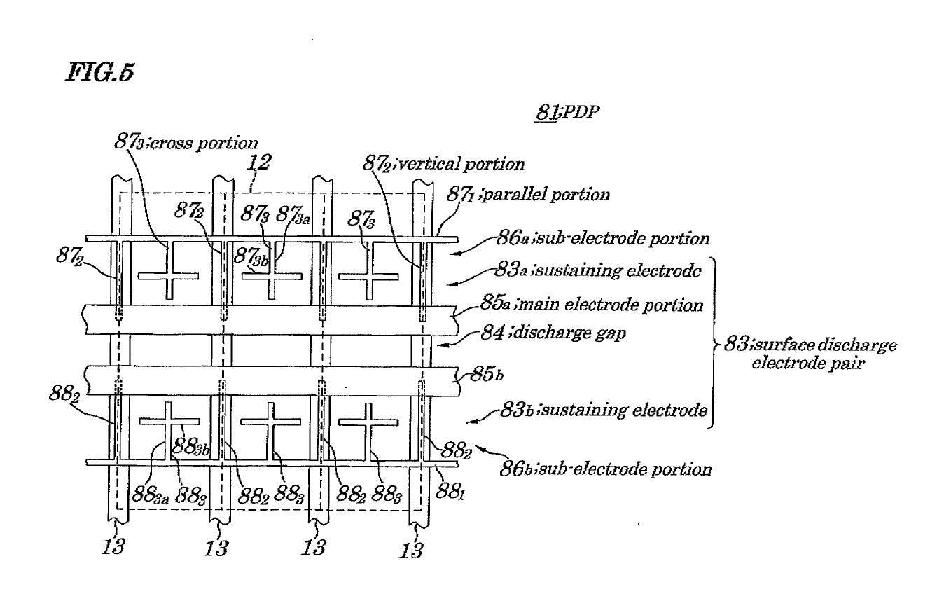

FIG. 5 is a top view showing an AC driving surface discharge type of PDP 81 in that a front insulation substrate 82 is not shown according to a fourth embodiment of the present invention.

In the PDP 81, under the front insulation substrate 82 (not shown), as shown in FIG. 5, a plurality of pairs of sustaining electrodes 83a and sustaining electrodes 83b extending in a row direction (in a horizontal direction in FIG. 5) as whole are alternately arranged in a column direction (in a vertical direction in FIG. 5) at predetermined intervals so that a discharge gap 84 is put between each pair. The front insulation substrate 82 is made of soda lime glass or a like so as to have a thickness of 2 mm to 5 mm. The sustaining electrode 83a and the sustaining electrode 83b form a surface discharge electrode pair 83. The sustaining electrode 83a includes a main electrode portion 85a and a sub-electrode portion 86a. Similarly, the sustaining electrode 83b includes a main electrode portion 85b and a sub-electrode portion 86b.

Both of the main electrode portion 85a and the main electrode portion 85b are made up of transparent conductive thin films in stripe shapes such as tin oxide, indium oxide, or ITO (Indium Tin Oxide). Widths of the main electrode portion 85a and the main electrode portion 85b are 30 μm to 100 μm, preferably, 40 μm to 80 μm. A plurality of pairs of sub-electrode portions 86a and sub-electrode portions 86b are formed at under layers of the main electrode portion 85a and the main electrode portion 85b so as to correspond with the main electrode portion 85a and the main electrode portion 85b. The sub-electrode portion 86a is made up of a metal film such as thick film of silver, and a thin film of aluminum, copper or a like, and is provided with a parallel portion 87₁, a plurality of vertical portions 87₂ provided on a division wall 13, and a plurality of cross parts 87₃ provided for each display cell 12. The parallel portion 87₁ is formed in parallel with the main electrode portion 85a at a predetermined distance from the main electrode portion 85a so as to extend in the row direction. Each vertical portion 87₂ is integrated with the parallel portion 87₁ and extends in the column direction perpendicular to the parallel portion 87₁ and to the main electrode portion 85a over the division wall 13. an upper face end portion of each vertical portion 87₂ is electrically in contact with the lower face of the main electrode portion 85a. Each cross part 87₃ is integrated with the parallel portion 87₁ is formed over a position at which distances from adjacent division wall 13 in the display cell 12 in an area surrounded by a dashed line in FIG. 5 are approximately equal. Each cross part 87₃ is provided with a vertical portion 87₃ₐ and a parallel portion 87_{3b}. The vertical portion 87₃ₐ extends to the main electrode 85a in the column direction perpendicular to the parallel portion 87_{3b}. A top of the vertical portion 87₃ₐ reaches near a side face opposite to the side facing the discharge gap 84 of the main electrode portion 85a. The parallel portion 87_{3b} extends from an approximate center to two adjacent vertical portions 87₂ in the row direction and reaches near the side of the vertical portion 87₂. Similarly, the sub-electrode portion 86b is made up of metal films such as thick films of silver, or thin films of aluminum or copper and is provided with a first parallel portion 88₁, a plurality of vertical portions 88₂ formed on the division wall 13, a plurality of cross parts 88₃ formed for respective display cells 12. The sub-electrode portion 86a and the sub-electrode portion 86b are in a line-ymmetric relationship in which a center axis of the discharge gap 84 is used as a symmetry line, and therefore, no detailed explanations of the sub-electrode portion 86b will be given.

Widths of the parallel portion 87₁ and the parallel portion 88₁ are preferably 30 μm to 60 μm to reduce resistance values of the main electrode portion 85a and the main electrode portion 85b of which conductivity is low. In other words, the parallel portion 87₁ and the first parallel portion 88₁ function similarly to conventional bus electrodes. It is preferable that widths of the vertical portion 87₂ and the vertical portion 88₂ are equal to the width of the division wall 13 or narrower than the width of the division wall 13 from points of luminous efficiency and luminance. And, it is preferable that widths of the vertical portion 87₂ and the vertical portion 88₂ are a half of the width of the division wall 13 or less from points of manufacturing. Widths of the cross part 87₃ and the cross part 88₃ are 1 μm to 50 μm, preferably, 1 μm to 30 μm. In the fourth embodiment, both of an interval between the main electrode portion 85a and the parallel portion 87₁, and an interval between the main electrode portion 85b and the parallel portion 88₁ are 60 μm to 280 μm.

Additionally, the main electrode portion 85a and the main electrode portion 85b, the sub-electrode portion 86a and the sub-electrode portion 86b, and a dielectric layer and a protection layer (both not shown) which may be sequentially formed on a lower face of the front insulation substrate 82 (not shown) on which no main electrode portion 85a and no main electrode portion 85b, and no sub-electrode portion 86a and no sub-electrode portion 86b are formed are similar to those of the conventional PDP, and therefore, no explanations of those will be given. Also, a data electrode, a dielectric layer, a division wall, and three kinds of fluorescent layers (all not shown) which are sequentially formed on a back insulation substrate (not shown), and discharge gas to be filled up in a discharge gas space (not shown) are similar to those of a conventional PDP, and therefore, no explanations of those will be given. Also, a method of forming the sustaining electrode 83a and the sustaining electrode 83b included in the PDP 81 is approximately similar to that of the first embodiment except that a pattern shape in patterning a photosensitive dry film 41 (shown in FIG. 2A) and photosensitive silver paste 43 (shown in FIG. 2E) since shapes of the sub-electrode portion 86a and the sub-electrode 86b are different from those of a sub-electrode portion 36a (shown in FIG. 1) and a sub-electrode portion 36b (shown in FIG. 1). Therefore, no explanations of the method will be given.

As described above, with the fourth embodiment, differently from the second embodiment, as to the cross part 87₃, the upper face of the end portion of the vertical portion 87₃ₐ is not electrically in contact with the lower face of the main electrode 85a, and the end portion of the vertical portion 87₃ₐ is not electrically contact with the side of the adjacent vertical portion 87₂. Therefore, according to the structure of the fourth embodiment, since it is possible to reduce an area of metal film which is not transparent and intercepts visible lights in comparison with the second embodiment, it is possible to make luminance higher and to improve luminous efficiency more.

### Fifth Embodiment

A fifth embodiment of the present invention will be described.

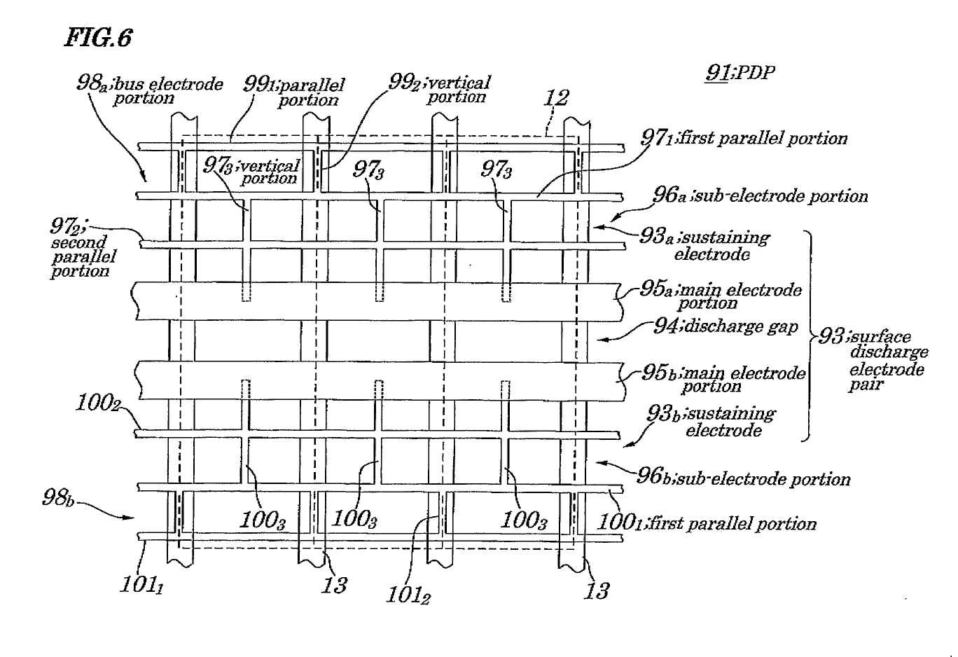

FIG. 6 is a top view showing an AC driving surface discharge type of PDP 91 in that a front insulation substrate 92 is not shown, according to a fifth embodiment of the present invention.

In the PDP 91, under the front insulation substrate 92 (not shown), as shown in FIG. 6, a plurality of pairs of sustaining electrodes 93a and sustaining electrodes 93b extending in a row direction (in a horizontal direction in FIG. 6) as whole are alternately arranged in a column direction (in a vertical direction in FIG. 6) at predetermined intervals so that a discharge gap 94 is put between each pair. The front insulation substrate 92 (not shown) is made of soda lime glass or a like so as to have a thickness of 2 mm to 5 mm. The sustaining electrode 93a and the sustaining electrode 93b form a surface discharge electrode pair 93. The sustaining electrode 93a includes a main electrode portion 95a and a sub-electrode portion 96a. Similarly, the sustaining electrode 93b includes a main electrode portion 95b and a sub-electrode portion 96b.

Both of the main electrode portion 95a and the main electrode portion 95b are made up of transparent conductive thin films in stripe shapes such as tin oxide, indium oxide, or ITO (Indium Tin Oxide). Widths of the main electrode portion 95a and the main electrode portion 95b are 30 μm to 100 μm, preferably, 40 μm to 80 μm. A plurality of pairs of sub-electrode portions 96a and sub-electrode portions 96b and a plurality of pairs of bus electrode portions 98a and bus electrode portions 98b are formed at under layers of the main electrode portion 95a and the main electrode portion 95b so as to correspond the main electrode portion 95a and the main electrode portion 95b. The sub-electrode 96a is made up of a metal film such as thick film of silver, and a thin film of aluminum, copper or a like, and is provided with a first parallel portion 97₁, a second parallel portion 97₂, a plurality of vertical portions 97₃ provided for each display cell 12. The first parallel portion 97₁ is formed in parallel with the main electrode portion 95a at a predetermined distance from the main electrode portion 95a so as to extend in the row direction. The second parallel portion 97₂ is formed between the main electrode portion 95a and the first parallel portion 97₁ in parallel with the main electrode portion 95a at a predetermined distance from the main electrode portion 95a so as to extend in the row direction. Each vertical portion 97₃ is integrated with the first parallel portion 97₁ and the second parallel portion 97₂, and extends in the column direction perpendicular to the first parallel portion 97₁ and the second parallel portion 97₂. Each top of the vertical portion 97₃ is electrically in contact with the lower face of the main electrode portion 95a. Each vertical portion 97₃ is formed over a position at which distances from adjacent division walls 13 in the display cell 12 in an area surrounded by a dashed line in FIG. 6 are approximately equal. Also, the bus electrode portion 98a is made up of a metal film such as thick film of silver, and a thin film of aluminum, copper or a like, is integrated with the sub-electrode portion 96a, and is provided with a parallel portion 99₁, and a plurality of vertical portions 99₂ provided over the division wall 13. The parallel portion 99₁ is formed in parallel with the first parallel portion 97₁ at a predetermined distance from the first parallel portion 97₁ as not to be influenced by the discharge and so as to extend in the row direction. Each vertical portion 99₃ is integrated with the first parallel portion 97₁, the second parallel portion 97₂, and the parallel portion 99₁ and extends in the column direction perpendicular to the first parallel portion 97₁, the second parallel portion 97₂ and the parallel portion 99₁, an upper face of an end portion of each vertical portion 97₃ is electrically in contact with the lower face of the first parallel portion 97₁. Similarly, the sub-electrode portion 96b is made up of metal films such as thick films of silver, or thin films of aluminum or copper and is provided with a first parallel portion 100₁, a second parallel portion 100₂, a plurality of vertical portions 100₃ formed for respective display cells 12. Also, the bus electrode portion 98b is made up of metal films such as thick films of silver, or thin films of aluminum or copper, is integrated with the sub-electrode portion 96b and is provided with a parallel portion 101₁, and a plurality of vertical portions 101₂ formed over the division wall 13. The sub-electrode portion 96a and the sub-electrode portion 96b are in a line-ymmetric relationship in which a center axis of the discharge gap 94 is used as a symmetry line, and therefore, no detailed explanations of the sub-electrode portion 96b will given. Similarly, the bus electrode portion 98a and the bus electrode portion 98b are in a line-ymmetric relationship in which a center axis of the discharge gap 94 is used as a symmetry line, and therefore, no detailed explanations of the bus-electrode portion 96b will given.

Widths of the first parallel portion 97₁ and the first parallel portion 100₁, widths of the second parallel portion 97₂ and the second parallel portion 100₂, widths of the vertical portion 97₃ and the vertical portion 100₃ are 1 μm to 50 μm, preferably, 1 μm to 30 μm. In the fifth embodiment, both of an interval between the main electrode portion 95a and the second parallel portion 97₂, and an interval between the second parallel portion 97₂ and the first parallel portion 97₁ are 30 μm to 140 μm. Similarly, both of an interval between the main electrode portion 95b and the second parallel portion 100₂, and an interval between the second parallel portion 100₂ and the first parallel portion 100₁ are 30 μm to 140 μm. Also, both of an interval between the parallel portion 99₁ and the parallel portion 100₂, forming the bus electrode portion 98a and the bus electrode portion 98b are preferably 30 μm to 60 μm to reduce the resistance values of the main electrode portion 95a and the main electrode portion 95b of which conductivity is low.

Additionally, the main electrode portion 95a and the main electrode portion 95b, the sub-electrode portion 96a and the sub-electrode portion 96b, the bus electrode portion 98a and the bus electrode portion 98b, and a dielectric layer (not shown) and a protection layer (not shown) which may be sequentially formed on a lower face of the front insulation substrate 92 (not shown) on which no main electrode portion 95a and no main electrode portion 95b, no sub-electrode portion 96a and no sub-electrode portion 96b, and no bus electrode portion 98a and no bus electrode portion 98b are formed are similar to those of a conventional PDP, and therefore, no explanations of those will be given. Also, a data electrode, a dielectric layer, a division wall, and three kinds of fluorescent layers (all not shown) which are sequentially formed on the back insulation substrate (not shown), and discharge gas to be filled up in a discharge gas space (not shown) are similar to those of the conventional PDP, and therefore, no explanations of those will be given. Also, a method of forming the sustaining electrode 93a and the sustaining electrode 93b and the bus electrode portion 98a and the bus electrode portion 98b included in the PDP 91 is approximately similar to that of the first embodiment except that a pattern shape in patterning of a photosensitive silver paste 43 (shown in FIG. 2E) since shapes of the sub-electrode portion 96a and the sub-electrode 96b are different from those of the sub-electrode portion 36a (shown in FIG. 1) and the sub-electrode portion 36b (shown in FIG. 1) and the bus electrode portion 98a and the bus electrode portion 98b are provided. Therefore, no explanations of the method will be given.

As described above, with the configuration of the fifth embodiment, since the bus electrode portion 98a and the bus electrode portion 98b are provided, the following effects can be obtained in addition to those of the first embodiment. Since the resistance values of the main electrode portion 95a and the main electrode portion 95b of which each conductivity is low are reduced by the parallel portion 99₁ and the parallel portion 100₁ included in the bus electrode portion 98a and the bus electrode portion 98b, it is unnecessary to reduce the resistance values by the first parallel portion 97₁ and the first parallel portion 100₁. With this structure, it is unnecessary to make the widths of the first parallel portion 97₁ and the first parallel portion 100₁ larger to diffuse the discharge into the first parallel portion 97₁ and the first parallel portion 100₁. Therefore, since it is possible to reduce the area of metal film which is not transparent and intercepts visible lights in comparison with the first embodiment, it is possible to make luminance higher and to improve luminous efficiency more.

It is thus apparent that the present invention is not limited to the above embodiments but may be changed and modified without departing from the scope and spirit of the invention.

For example, the first embodiment, as shown in FIG. 2A to FIG. 2F, shows the method in which the sub-electrode portion 36a and the sub-electrode portion 36b are formed after the main electrode portion 35a and the main electrode portion 35b are formed. The present invention is not limited to this, and the main electrode portion 35a and the main electrode portion 35b may be formed after the sub-electrode portion 36a and the sub-electrode portion 36b are formed. Other embodiments are similar to this.

Also, the first embodiment shows the method in which the sub-electrode portion 36a and the sub-electrode portion 36b are formed by patterning the photosensitive silver paste 43. However, the present invention is not limited to this, and the sub-electrode portion 36a and the sub-electrode portion 36b (both shown in FIG. 1) may be formed by annealing after patterning the photosensitive silver paste 43 (shown in FIG. 2E). Other embodiments are similar to this. When the sub-electrode portion 36a and the sub-electrode portion 36b are formed by patterning of the photosensitive silver paste 43, there are advantages in that the process can be made simpler than and use rate of materials can be more improved than a case in which the sub-electrode portion 36a and the sub-electrode portion 36b are formed by patterning the photosensitive silver paste 43.

Also, if only there is no discrepancy in the object and the structures, all embodiments can be diverted one another. For example, the bus electrode portion 98a and the bus electrode portion 98b may be integrated with sub-electrode portions in another embodiment.

What is claimed is:

1. A plasma display panel having a plurality of surface discharge electrode pairs formed in a column direction at predetermined intervals, each of said surface discharge electrode pairs having a pair of sustaining electrodes extending in a row direction so that a discharge gap is put between said sustaining electrodes, wherein:
each of said sustaining electrodes is made up of a transparent conductive thin film, is provided with a main electrode portion formed in stripe shapes so as to face said discharge gap and a metal film of which a width is narrower than a width of said main electrode portion, and a sub-electrode portion formed at a side opposite to the discharge gap side of said main electrode portion which corresponds.

2. The plasma display panel according to claim 1, wherein said sub-electrode portion is provided with a first parallel portion extending in said row direction at a predetermined distance from said main electrode portion, and a second parallel portion extending in said row direction at a predetermined distance from said first parallel portion between said main electrode portion and said first parallel portion.

3. The plasma display panel according to claim 2, wherein said sub-electrode portion is provided with a vertical portion extending to said main electrode portion at a position at which distances from adjacent division walls extending in said column direction for separating each display cell are approximately equal and integrated with said first parallel portion and said second parallel portion in a manner that an end portion of said vertical portion is electrically in contact with said main electrode portion.

4. The plasma display panel according to claim 2, wherein said sub-electrode portion is provided with a first vertical portion extending to said main electrode portion at a position at which distances from adjacent division walls extending in said column direction for separating each display cell are approximately equal and integrated with said first parallel portion and said second parallel portion in a manner that an end portion of said first vertical portion is electrically in contact with said main electrode portion, and a second vertical portion extending to said main electrode portion in said column direction at an upper side of said division wall and integrated with said first parallel portion and said second parallel portion in a manner that an end portion of said second vertical portion is electrically in contact with said main electrode portion.

5. The plasma display panel according to claim 4, wherein said a width of said second vertical portion is equal to a width of said division wall or is narrower than said width of said division wall.

6. The plasma display panel according to claim 4, wherein said a width of said second vertical portion is a half of a width of said division wall or less.

7. The plasma display panel according to claim 2, wherein said a width of said second parallel portion is 1 μm to 50 μm.

8. The plasma display panel according to claim 2, wherein said a width of said second parallel portion is 1 μm to 30 μm.

9. The plasma display panel according to claim 4, wherein said a width of said first vertical parallel portion is 1 μm to 50 μm.

10. The plasma display panel according to claim 4, wherein said a width of said first vertical parallel portion is 1 μm to 30 μm.

11. The plasma display panel according to claim 4, wherein said main electrode portion is provided with a main electrode parallel portion extending in said row direction, and a main electrode projection part projecting from said main electrode portion at a side opposite to the discharge gap side of said main electrode portion at a position at which distances from adjacent division wall extending in said column direction to separate each display cell are approximately equal, and said first vertical portion extends to said main electrode portion in said column direction perpendicular to said first parallel portion and said second parallel portion and is integrated with said first parallel portion and said second parallel portion in a manner that an end portion of said first vertical portion is electrically in contact with said main electrode portion which corresponds.

12. The plasma display panel according to claim 11, wherein lengths of said main electrode projection part in said row direction and in said column direction are 30 μm to 60 μm.

13. The plasma display panel according to claim 1, wherein said sub-electrode portion is provided with a first parallel portion extending in said row direction at a predetermined distance from said main electrode portion, a first vertical portion extending to said main electrode portion in said column direction over each division wall extending in said column direction so as to separate each display cell and integrated with said first parallel portion in a manner that an end portion of said first vertical portion is electrically in contact with said main electrode portion, and a cross parts including a second vertical portion extending to said main electrode portion in said column direction at a position at which distances from adjacent division walls are approximately equal and an end portion of said second vertical portion reaching near a side face of said main electrode portion, and second parallel portions respectively extending from an approximate center to said first vertical portions which are adjacent in a manner that an end portion of each of said second parallel portions reaches near said first vertical portions which are adjacent, said cross part integrated with said first vertical portion.

14. The plasma display panel according to claim 13, wherein a width of said first vertical portion is equal to a width of said division wall or is narrower than a width of said division wall.

15. The plasma display panel according to claim 13, wherein a width of said first vertical portion is a half of a width of said division wall or less.

16. The plasma display panel according to claim 2, further comprising;
a bus electrode portion comprising a bus electrode parallel portion extending in said row direction in parallel with said first parallel portion at a distance at which there is no influence from said first parallel portion, and a bus electrode vertical portion extending to said first parallel portion in said column direction perpendicular to said first parallel portion and said bus parallel portion in a manner that an end portion of said bus electrode vertical portion is electrically in contact with said first parallel portion, and said bus electrode portion is integrated with said sub-electrode portion.

17. The plasma display panel according to claim 1, wherein a width of said main electrode portion is 30 μm to 100 μm.

18. The plasma display panel according to claim 1, wherein a width of said main electrode portion is 40 μm to 80 μm.

19. The plasma display panel according to claim 11, wherein widths of said first parallel portion and said second parallel portion are 30 μm to 100 μm.

20. The plasma display panel according to claim 11, wherein widths of said first parallel portion and said second parallel portion are 40 μm to 80 μm.

21. The plasma display panel according to claim 2, wherein a width of said first parallel portion is 30 μm to 60 μm.

22. The plasma display panel according to claim 2, wherein both of an interval between said main electrode portion and said first parallel portion, and an interval between said second parallel portion and said first parallel portion are 30 μm to 140 μm.

23. A method of manufacturing a plasma display panel which has a plurality of surface discharge electrode pairs formed in a column direction at predetermined intervals, each of said surface discharge electrode pairs having a pair of sustaining electrodes extending in a row direction so that a discharge gap is put between said sustaining electrodes, wherein: each of said sustaining electrodes is made up of a transparent conductive thin film, is provided with a main electrode portion formed in stripe shapes so as to face said discharge gap and a metal film of which a width is narrower than a width of said main electrode portion, and a sub-electrode portion formed at a side opposite to the discharge gap side of said main electrode portion which corresponds, said method comprising:
a first step of coating photosensitive silver paste on a front insulation substrate or a front insulation substrate after forming a plurality of surface discharge pair; and
a second step of forming said sub-electrode portion by annealing after exposing and developing said photosensitive silver paste and patterning said photosensitive silver paste.

24. A method of manufacturing a plasma display panel which has a plurality of surface discharge electrode pairs formed in a column direction at predetermined intervals, each of said surface discharge electrode pairs having a pair of sustaining electrodes extending in a row direction so that a discharge gap is put between said sustaining electrodes, wherein: each of said sustaining electrodes is made up of a transparent conductive thin film, is provided with a main electrode portion formed in stripe shapes so as to face said discharge gap and a metal film of which a width is narrower than a width of said main electrode portion, and a sub-electrode portion formed at a side opposite to the discharge gap side of said main electrode portion which corresponds, said method comprising:
a first step of coating silver paste on a front insulation substrate or a front insulation substrate after forming a plurality of surface discharge pair; and
a second step of forming said sub-electrode portion by annealing after patterning said photosensitive silver paste.
